(19) United States
(12) Patent Application Publication
(10) Pub. No.: US 2023/0393599 A1
(43) Pub. Date: Dec. 7, 2023

(54) CURRENT DETECTION CIRCUIT, OVERCURRENT PROTECTION CIRCUIT, AND LINEAR POWER SUPPLY

(71) Applicant: Rohm Co., Ltd., Kyoto (JP)

(72) Inventor: Makoto YASUSAKA, Kyoto (JP)

(21) Appl. No.: 18/327,633

(22) Filed: Jun. 1, 2023

(30) Foreign Application Priority Data
Jun. 7, 2022 (JP) 2022-092295

(51) Int. Cl. G05F 1/575; G05F 3/26; G05F 1/573

(52) U.S. Cl. CPC G05F 1/575; G05F 3/262; G05F 1/573

(57) ABSTRACT

A current detection circuit includes: a first transistor configured to pass a sense current corresponding to a monitoring target current; a second transistor provided on a path through which the sense current flows, and configured such that a voltage across the second transistor is extracted as a current detection signal; and a third transistor having a control terminal connected to a control terminal of the second transistor, having a higher on-threshold voltage than the second transistor, and configured to drive the second transistor in a linear region.

### CROSS-REFERENCE TO RELATED APPLICATION

This application is based upon and claims the benefit of priority from Japanese Patent Application No. 2022-092295, filed on Jun. 7, 2022, the entire contents of which are incorporated herein by reference.

### TECHNICAL FIELD

The present disclosure relates to a current detection circuit, an overcurrent protection circuit using the same, and a linear power supply.

### BACKGROUND

A current detection circuit that detects a monitoring target current is used for various purposes (e.g., an overcurrent protection circuit that limits an output current flowing through an output transistor to a predetermined upper limit value or less).

However, conventional current detection circuits have room for improvement in terms of detection accuracy thereof.

### SUMMARY

Some embodiments of the present disclosure provide a current detection circuit with high detection accuracy, an overcurrent protection circuit using the current detection circuit, and a linear power supply.

According to one embodiment of the present disclosure, a current detection circuit includes: a first transistor configured to pass a sense current corresponding to a monitoring target current; a second transistor provided on a path through which the sense current flows, and configured such that a voltage across the second transistor is extracted as a current detection signal; and a third transistor having a control terminal connected to a control terminal of the second transistor, having a higher on-threshold voltage than the second transistor, and configured to drive the second transistor in a linear region.

Other features, elements, steps, advantages, and characteristics will become more apparent from the following detailed description and the accompanying drawings related thereto.

### BRIEF DESCRIPTION OF DRAWINGS

The accompanying drawings, which are incorporated in and constitute a part of the specification, illustrate embodiments of the present disclosure.

FIG. 1 is a diagram showing a comparative example of a linear power supply.

FIG. 2 is a diagram showing a first embodiment of a linear power supply.

FIG. 3 is a diagram showing Ron-Vgs characteristics of a MOSFET.

FIG. 4 is a diagram showing Ron-Vth variation characteristics of a MOSFET.

FIG. 5 is a diagram showing Vds-Id characteristics of a MOSFET.

FIG. 6 is a diagram showing a variation in an overcurrent upper limit value in a comparative example.

FIG. 7 is a diagram showing a variation in an overcurrent upper limit value in the first embodiment.

FIG. 8 is a diagram showing a second embodiment of a linear power supply.

FIG. 9 is a diagram showing a third embodiment of a linear power supply.

FIG. 10 is a diagram showing a fourth embodiment of a linear power supply.

FIG. 11 is a diagram showing a fifth embodiment of a linear power supply.

FIG. 12 is a diagram showing a sixth embodiment of a linear power supply.

FIG. 13 is a diagram showing a seventh embodiment of a linear power supply.

FIG. 14 is a diagram showing an eighth embodiment of a linear power supply.

FIG. 15 is a diagram showing a ninth embodiment of a linear power supply.

FIG. 16 is a diagram showing a tenth embodiment of a linear power supply.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### <Linear Power Supply (Comparative Example)>

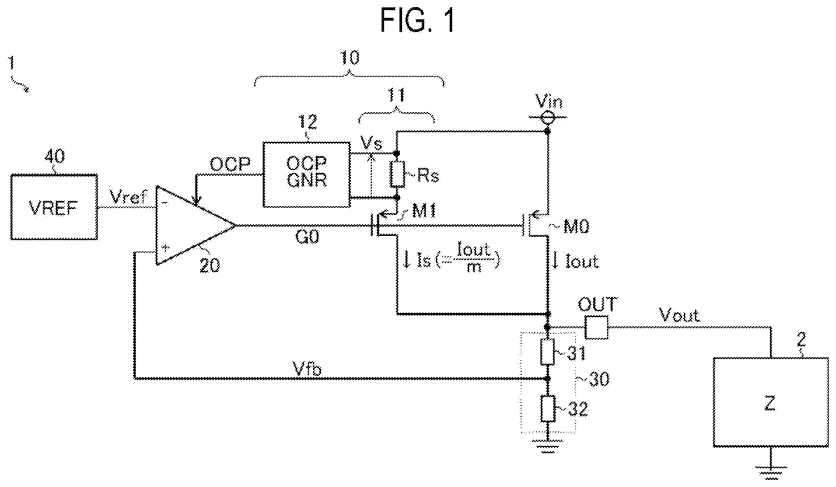

FIG. 1 is a diagram showing a comparative example of a linear power supply (an example of a general circuit configuration compared with the embodiments described later). The linear power supply 1 of this comparative example generates a desired output voltage Vout from an input voltage Vin and supplies the output voltage Vout to a load 2 connected to an output terminal OUT. For example, the linear power supply 1 may be an LDO (low drop out) regulator.

Referring to FIG. 1, the linear power supply 1 includes an output transistor M0, an overcurrent protection circuit 10, a driver 20, a feedback voltage generation circuit 30, and a reference voltage generation circuit 40. A part or all of these components may be integrated in a semiconductor device.

The output transistor M0 is connected between an application terminal of the input voltage Vin and an application terminal of the output voltage Vout. Referring to FIG. 1, the output transistor M0 may be, for example, a PMOSFET (P-channel type metal oxide semiconductor field effect transistor). In this case, the source of the output transistor M0 is connected to the application terminal of the input voltage Vin, and a drain of the output transistor M0 is connected to the application terminal of the output voltage Vout.

The overcurrent protection circuit 10 is connected between the application terminal of the input voltage Vin and the application terminal of the output voltage Vout, and generates an overcurrent protection signal OCP using an output current Tout flowing through the output transistor M0 as a monitoring target current (details will be described later).

The driver 20 controls the driving of the output transistor M0. Referring to FIG. 1, the driver 20 is an operational amplifier that generates a gate signal G0 of the output transistor M0 so that a feedback voltage Vfb inputted to a non-inverting input terminal (+) matches a reference voltage Vref inputted to an inverting input terminal (−). The gate signal G0 decreases when the feedback voltage Vfb is lower than the reference voltage Vref, and increases when the feedback voltage Vfb is higher than the reference voltage Vref. The driver 20 may have a function of adjusting the gate signal G0 so as to limit the output current Iout to an overcurrent upper limit value Iocp or less according to the overcurrent protection signal OCP.

The feedback voltage generation circuit 30 includes resistors 31 and 32 connected in series between an output terminal OUT and a ground terminal, and divides the output voltage Vout to generate a feedback voltage Vfb. The feedback voltage generation circuit 30 may be omitted and the output voltage Vout may be directly inputted to the driver 20.

The reference voltage generation circuit 40 generates a reference voltage Vref that is less affected by the input voltage Vin and the ambient temperature, and outputs the reference voltage Vref to the inverting input terminal (−) of the driver 20.

### <Overcurrent Protection Circuit>

Next, the overcurrent protection circuit 10 will be described in detail with reference to FIG. 1. The overcurrent protection circuit 10 of this comparative example includes a current detection circuit 11 and a protection signal generation circuit 12.

The current detection circuit 11 includes a transistor M1 and a sense resistor Rs, and generates a current detection signal Vs according to the output current Tout.

A source of the transistor M1 (e.g., PMOSFET) is connected to the source of the output transistor M0 via the sense resistor Rs. A drain of the transistor M1 is connected to the drain of the output transistor M0. A gate of the transistor M1 is connected to a gate of the output transistor M0 (application terminal of the gate signal G0).

The on-resistance (conductivity) of the transistor M1 connected in this manner is controlled in the same manner as the on-resistance (conductivity) of the output transistor M0. Therefore, a sense current Is (Iout/m where m>1) proportional to the output current Tout flows through the transistor M1. The sense current Is flows from the application terminal of the input voltage Vin to the application terminal of the output voltage Vout via the sense resistor Rs and the transistor M1.

The sense resistor Rs is provided on the path through which the sense current Is flows, and the voltage across the sense resistor Rs is extracted as a current detection signal Vs (=Is×Rs).

The protection signal generation circuit 12 generates an overcurrent protection signal OCP for limiting the output current Tout to an overcurrent upper limit value Iocp or less based on the current detection signal Vs. The overcurrent protection circuit 10 may control the driver 20 according to the overcurrent protection signal OCP, or may directly adjust the gate signal G0.

With such a configuration including the overcurrent protection circuit 10, it is possible to limit the output current Tout even when an abnormality occurs in the load 2 and an excessive output current Tout may flow. Accordingly, it is possible to protect the linear power supply 1 and its peripheral circuits.

### <Consideration on Current Detection Accuracy>

Factors that may affect the detection accuracy of the current detection circuit 11 include a variation in pair ratio between the output transistor M0 and the transistor M1, a variation in absolute value of the sense resistor Rs, and a variation in input offset of the protection signal generation circuit 12.

In particular, in view of integration into a semiconductor device, it is general that the absolute value variation is larger than the mismatch variation. That is, it is considered that among the factors described above, the variation in absolute value of the sense resistor Rs greatly affects the detection accuracy of the current detection circuit 11.

In view of the above considerations, various embodiments that can improve the detection accuracy of the current detection circuit 11 are proposed below.

### Linear Power Supply (First Embodiment)

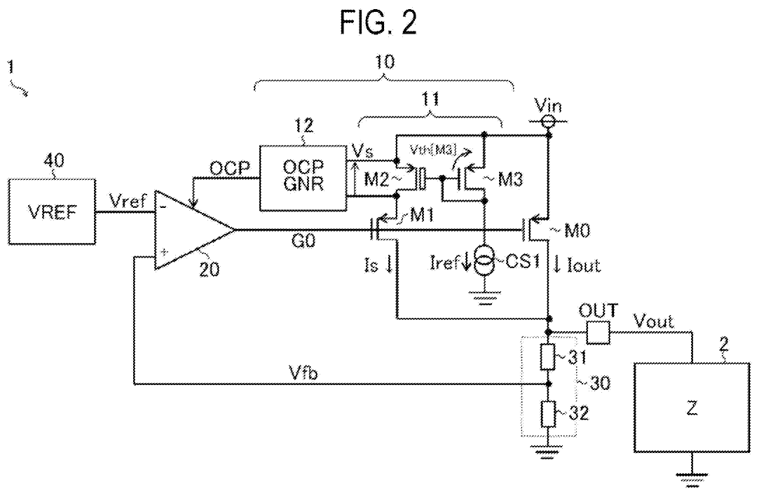

FIG. 2 is a diagram showing a first embodiment of the linear power supply. The linear power supply 1 of the first embodiment is based on the previously described comparative example (FIG. 1) and includes transistors (e.g., PMOSFETs) M2 and M3 and a current source CS1 instead of the sense resistor Rs.

A source of the transistor M2 is connected to the source of the output transistor M0 (the application terminal of the input voltage Vin). A drain of the transistor M2 is connected to the source of the transistor M1. The drain of the transistor M1 is connected to the drain of the output transistor M0 (the application terminal of the output voltage Vout).

A source of the transistor M3 is connected to the source of the output transistor M0. Gates of the transistors M2 and M3 are both connected to a drain of the transistor M3. The drain of the transistor M3 is connected to a first terminal of the current source CS1. A second terminal of the current source CS1 is connected to the ground terminal.

The transistor M1 corresponds to a first transistor configured to pass a sense current Is corresponding to the output current Iout.

The transistor M2 corresponds to a second transistor provided on a path through which the sense current Is flows, and is configured such that the voltage across the transistor (drain-source voltage Vds) is extracted as a current detection signal Vs.

The transistor M3 corresponds to a third transistor having a higher on-threshold voltage Vth [M3] than the transistor M2 and is configured to drive the transistor M2 in a linear region.

Thus, the second transistor and the third transistor constituting the current detection circuit 11 may be provided on the source side of the first transistor. For example, when the second transistor and the third transistor are provided on the source side of the P-channel transistor M1, P-channel transistors M2 and M3 may be used as the second transistor and the third transistor, respectively.

However, the transistor M2 is a PMOSFET having a gate electrode formed of high-concentration P-type polysilicon. In the following description, the transistor M2 may be referred to as “P-gate PMOSFET” to distinguish it from a typical PMOSFET. On the other hand, the transistor M3 is a typical PMOSFET having a gate electrode made of high-concentration N-type polysilicon. That is, the transistors M2 and M3 are both PMOSFETs having the same structure, and the polarities of the gate electrodes thereof are different.

The P-gate PMOSFET is a PMOSFET whose on-threshold voltage Vth is changed by changing the polarity of the gate electrode. A typical PMOSFET has an on-threshold voltage Vth of about 0.7 V. On the other hand, in the P-gate PMOSFET, the on-threshold voltage Vth is about −0.15 V.

The P-gate PMOSFET and the typical PMOSFET have exactly the same device structure, except that the polarities of the gate electrodes are different. Therefore, as long as they are formed on a common silicon substrate, their element characteristics (on-threshold voltage Vth, on-resistance Ron, etc.) vary in the same way.

Further, as described above, the gates of the transistors M2 and M3 are both connected to the drain of the transistor M3. The reference current Tref generated by the current source CS1 flows through the drain of the transistor M3. Therefore, a potential difference corresponding to the on-threshold voltage Vth [M3] (≈0.7 V) of the transistor M3 is generated between the gate and source of the transistor M3.

The on-threshold voltage Vth [M3] of the transistor M3 is much higher than the on-threshold voltage Vth [M2] (≈0.15 V) of the transistor M2. Therefore, the transistor M2 is sufficiently driven in a linear region. In the linear region, the characteristic between the drain and source of the transistor M2 is equivalent to that of a resistor. That is, the current detection signal Vs extracted from between the drain and source of the transistor M2 is proportional to the sense current Is flowing through the transistor M1.

In the linear power supply 1 of the first embodiment, unlike the comparative example (FIG. 1) described above, there is no need to consider the variation in absolute value of the sense resistor Rs. Therefore, it is possible to enhance the detection accuracy of the current detection circuit 11, and eventually, it is possible to reduce the variation in the overcurrent upper limit value Iocp. A detailed description will be given below with reference to the drawings.

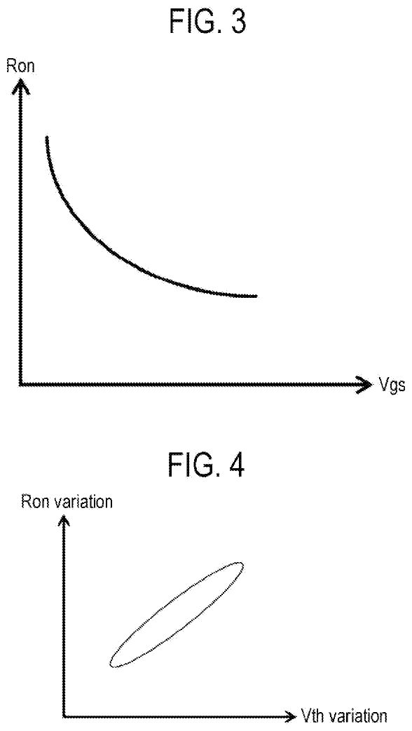

FIG. 3 is a diagram showing Ron-Vgs characteristics of a MOSFET (the correlation between the on-resistance Ron and the gate-source voltage Vgs).

As shown in FIG. 3, the on-resistance Ron of the MOSFET decreases as the gate-source voltage Vgs of the MOSFET increases. When the gate-source voltage Vgs of the MOSFET is sufficiently higher than the on-threshold voltage Vth of the MOSFET and when the MOSFET is driven in the linear region, the characteristic between the drain and source of the MOSFET is equivalent to that of a resistor.

FIG. 4 is a diagram showing the Ron-Vth variation characteristic of a MOSFET (the correlation between the variation in on-resistance Ron and the variation in on-threshold voltage Vth).

As shown in FIG. 4, there is a positive correlation between the variation in on-resistance Ron and the variation in on-threshold voltage Vth of the MOSFET. That is, when the on-threshold voltage Vth varies in a decreasing direction, the on-resistance value Ron varies in a decreasing direction. Conversely, when the on-threshold voltage Vth varies in an increasing direction, the on-resistance value Ron varies in an increasing direction.

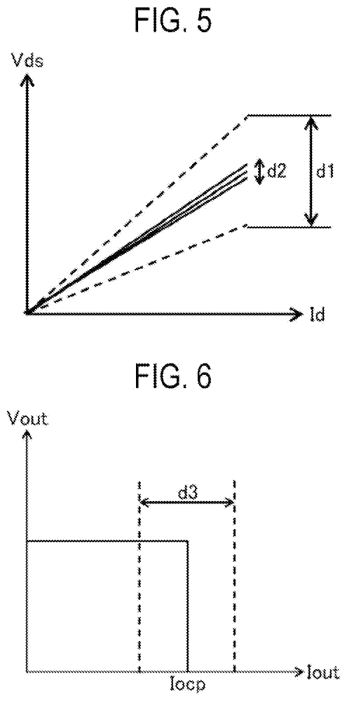

FIG. 5 is a diagram showing Vds-Id characteristics of a MOSFET (the correlation between the drain-source voltage Vds and the drain current Id with the gate-source voltage Vgs fixed). The solid line in FIG. 5 indicates the behavior of the first embodiment (FIG. 2). Further, the dashed line in FIG. 5 indicates the behavior of the comparative example (FIG. 1).

As described above, in the linear power supply 1 of the first embodiment, the transistor M2 (P gate PMOSFET) and the transistor M3 (typical PMOSFET) are different only in the polarity of the gate electrode, and the device structures thereof are exactly the same. Therefore, as long as they are formed on a common silicon substrate, the variations in their characteristics (the on-threshold voltages Vth [M2] and Vth [M3], the on-resistances Ron [M2] and Ron [M3], etc.) are the same.

For example, when the on-resistance Ron [M2] of the transistor M2 varies in an increasing direction, the on-threshold voltage Vth [M2], which has a positive correlation with the on-resistance Ron [M2], varies in an increasing direction (see FIG. 4 above). At this time, the on-threshold voltage Vth [M3] of the transistor M3, which has the same structure as the transistor M2, also varies in an increasing direction. As a result, the voltage applied to the gate of the transistor M2 increases. Therefore, the on-resistance Ron [M2] of the transistor M2 is lowered. Conversely, when the on-resistance Ron [M2] of the transistor M2 varies in a decreasing direction, the opposite action occurs to increase the on-resistance Ron [M2] of the transistor M2.

As described above, according to the linear power supply 1 of the first embodiment, the variation in on-resistance Ron [M2] of the transistor M2 is corrected. Therefore, the variation in the current detection signal Vs is reduced.

Referring to FIG. 5, in the comparative example (FIG. 1), the variation of the drain-source voltage Vds (current detection signal Vs) with respect to the drain current Id (sense current Is) is d1. This variation d1 is mainly determined by the absolute value variation of the sense resistor Rs.

On the other hand, according to the linear power supply 1 of the first embodiment, due to the correction action of the on-resistance Ron [M2] described above, the drain-source voltage Vds (current detection signal Vs) with respect to the drain current Id (sense current Is) is suppressed to d2 (<d1).

FIG. 6 is a diagram showing a variation in the overcurrent upper limit value Iocp in the comparative example (FIG. 1). The horizontal axis in FIG. 6 indicates the output current Iout, and the vertical axis in FIG. 6 indicates the output voltage Vout. In the above-described comparative example (FIG. 1), a variation d3 in the overcurrent upper limit value Iocp is several tens of percent (e.g., ±30%) because it is affected by the variation in absolute value of the sense resistor Rs.

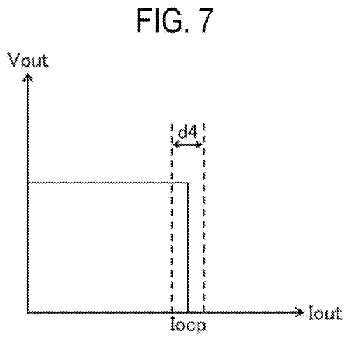

FIG. 7 is a diagram showing a variation in the overcurrent upper limit value Iocp in the first embodiment (FIG. 2). As in FIG. 6 described above, the horizontal axis in FIG. 7 indicates the output current Tout, and the vertical axis in FIG. 7 indicates the output voltage Vout. According to the linear power supply 1 of the first embodiment, a variation d4 in the overcurrent upper limit value Iocp can be reduced to several percent (e.g., ±5%) because it is not affected by the variation in absolute value of the sense resistor Rs.

### Linear Power Supply (Second Embodiment)

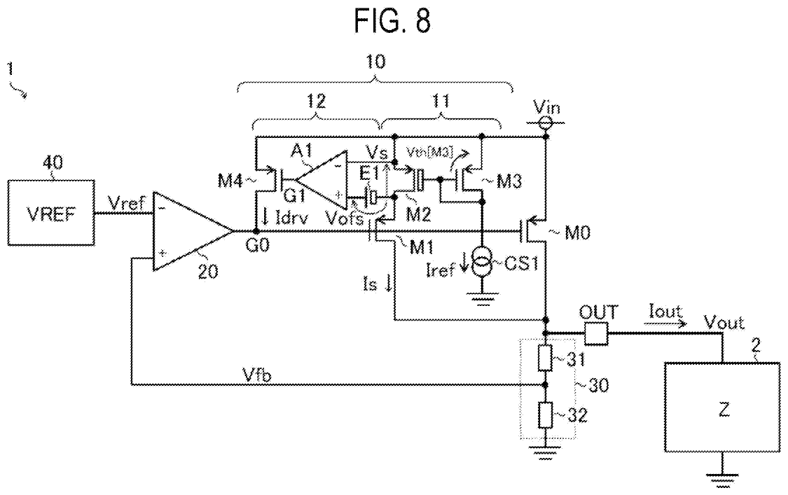

FIG. 8 is a diagram showing a second embodiment of the linear power supply. The linear power supply 1 of the second embodiment is based on the first embodiment (FIG. 2) described above, and includes an amplifier A1, a voltage source E1, and a transistor M4 (e.g., PMOSFET) as components of the protection signal generation circuit 12.

An inverting input terminal (−) of the amplifier A1 is connected to the source of the transistor M2. A non-inverting input terminal (+) of the amplifier A1 is connected to a positive terminal of the voltage source E1. A negative terminal of the voltage source E1 is connected to the drain of the transistor M2. An output terminal of the amplifier A1 is connected to a gate of the transistor M4. A source of the transistor M4 is connected to the application terminal of the input voltage Vin. A drain of the transistor M4 is connected to the output terminal of the driver 20.

The amplifier A1 uses the negative terminal of the voltage source E1 as a reference potential terminal, and generates a gate signal G1 so as to control an on-resistance (conductivity) of the transistor M4 according to a difference (Vofs−Vs) between the offset voltage Vofs (corresponding to the detection threshold value) inputted to the non-inverting input terminal (+) and the current detection signal Vs inputted to the inverting input terminal (−).

When the current detection signal Vs (=Is×Rs) is lower than the offset voltage Vofs, the gate signal G1 outputted from the amplifier A1 stays at a high level. Therefore, the transistor M4 is fully turned off so that the gate and source of the output transistor M0 are open. As a result, the on-resistance of the output transistor M0 is not increased, and the output current Tout flowing through the output transistor M0 is not limited (that is, the overcurrent protection operation is canceled).

On the other hand, when the output current Tout increases due to an output abnormality or the like and the current detection signal Vs becomes higher than the offset voltage Vofs, the gate signal G1 outputted from the amplifier A1 decreases from the high level according to the difference value between the two voltages. Therefore, the transistor M4 is turned on and the drive current Idry (corresponding to the overcurrent protection signal OCP) flows between the gate and source of the output transistor M0, so that the gate signal G0 rises and the gate and source of the output transistor M0 voltage is pulled down. As a result, the on-resistance of the output transistor M0 increases, resulting in a state in which the output current Tout is limited (i.e., a state in which the overcurrent protection operation is activated). Consequently, the gate control of the transistor M4 is balanced in a state in which the current detection signal Vs and the offset voltage Vofs are imaginary-shorted.

### Linear Power Supply (Third Embodiment)

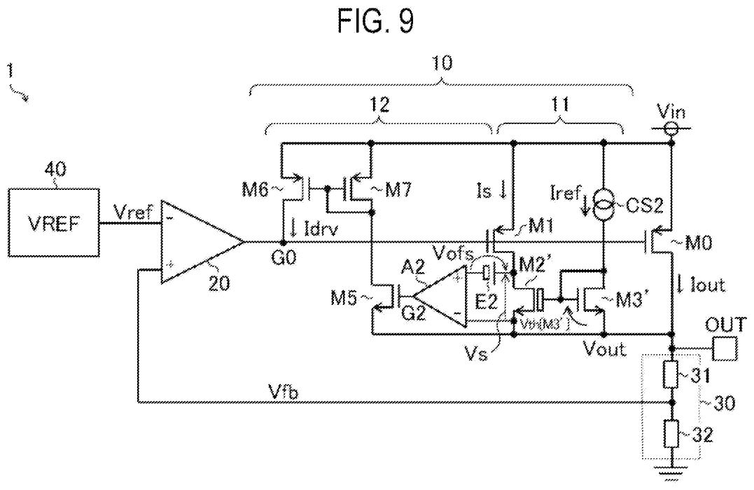

FIG. 9 is a diagram showing a third embodiment of the linear power supply. The linear power supply 1 of the third embodiment is based on the above-described second embodiment (FIG. 8), and the circuit configuration of the overcurrent protection circuit 10 is modified.

Specifically, referring to FIG. 9, the current detection circuit 11 includes transistors MT and M3′ (e.g., NMOSFETs [N-channel type MOSFETs]) and a current source CS2 instead of the transistors M2 and M3 and the current source CS1 described above.

Further, the protection signal generation circuit 12 includes an amplifier A2, a voltage source E2, a transistor M5 (e.g., NMOSFET), and transistors M6 and M7 (e.g., PMOSFETs) instead of the amplifier A1, the voltage source E1, and the transistor M4 described above.

The source of the transistor M1 is connected to the source of the output transistor M0 (i.e., the application terminal of the input voltage Vin). The drain of the transistor M1 is connected to a drain of the transistor MT. A source of the transistor MT is connected to the drain of the output transistor M0 (i.e., the application terminal of the output voltage Vout).

A source of the transistor M3′ is connected to the drain of the output transistor M0. Gates of the transistors MT and M3′ are both connected to a drain of the transistor M3′. The drain of the transistor M3′ is connected to a first terminal of the current source CS2. A second end of the current source CS2 is connected to the application terminal of the input voltage Vin.

The transistor M1 corresponds to a first transistor configured to pass a sense current Is corresponding to the output current Tout.

The transistor MT corresponds to a second transistor provided on a path through which the sense current Is flows, and is configured such that the voltage across the transistor (drain-source voltage Vds) is extracted as a current detection signal Vs.

The transistor M3′ has a higher on-threshold voltage Vth [M3′] than the transistor M2′, and corresponds to a third transistor configured to drive the transistor MT in a linear region.

As described above, the second transistor and the third transistor constituting the current detection circuit 11 may be provided on the drain side of the first transistor. For example, when the second transistor and the third transistor are provided on the drain side of the P-channel transistor M1, the N-channel transistors M2′ and M3′ may be used as the second transistor and the third transistor, respectively.

An inverting input terminal (−) of the amplifier A2 is connected to the source of the transistor MT. A non-inverting input terminal (+) of the amplifier A2 is connected to a negative terminal of the voltage source E2. A positive terminal of the voltage source E2 is connected to the drain of the transistor MT. An output terminal of the amplifier A2 is connected to a gate of the transistor M5. A source of the transistor M5 is connected to the application terminal of the output voltage Vout. A drain of the transistor M5 is connected to a drain of the transistor M7.

Sources of the transistors M6 and M7 are both connected to the application terminal of the input voltage Vin. Gates of the transistors M6 and M7 are both connected to the drain of the transistor M7. A drain of the transistor M6 is connected to the output terminal of the driver 20. The transistors M6 and M7 connected in this manner function as a current mirror that mirrors the drain current of the transistor M5 and generates a drive current Idry flowing between the gate and source of the output transistor M0.

The amplifier A2 uses the positive terminal of the voltage source E2 as a reference potential terminal, and generates a gate signal G2 so as to control an on-resistance (conductivity) of the transistor M5 according to a difference (Vs−Vofs) between the offset voltage Vofs (corresponding to the detection threshold value) inputted to the non-inverting input terminal (+) and the current detection signal Vs inputted to the inverting input terminal (−).

When the current detection signal Vs (=Is×Rs) is lower than the offset voltage Vofs, the gate signal G2 outputted from the amplifier A2 stays at a low level. Therefore, the transistor M5 is fully turned off so that the current mirror consisting of the transistors M6 and M7 does not operate and the gate and source of the output transistor M0 are open. As a result, the on-resistance of the output transistor M0 is not increased, and the output current Tout flowing through the output transistor M0 is not limited (that is, the overcurrent protection operation is canceled).

On the other hand, when the output current Tout increases due to an output abnormality or the like and the current detection signal Vs becomes higher than the offset voltage Vofs, the gate signal G2 outputted from the amplifier A2 rises from the low level according to the difference value between the two voltages. Therefore, the transistor M5 is turned on and the drive current Idry (corresponding to the overcurrent protection signal OCP) flows between the gate and source of the output transistor M0, so that the gate signal G0 rises and the gate-source voltage of the output transistor M0 is pulled down. As a result, the on-resistance of the output transistor M0 increases, resulting in a state in which the output current Tout is limited (i.e., a state in which the overcurrent protection operation is activated). Consequently, the gate control of the transistor M5 is balanced in a state in which the current detection signal Vs and the offset voltage Vofs are imaginary-shorted.

However, the transistor MT is an NMOSFET having a gate electrode formed of high-concentration N-type polysilicon. In the following description, the transistor MT may be referred to as an “N-gate NMOSFET” to distinguish it from a typical NMOSFET. On the other hand, the transistor M3′ is a typical NMOSFET having a gate electrode made of high-concentration P-type polysilicon. That is, the transistors MT and M3′ are both NMOSFETs having the same structure, and the polarities of the gate electrodes thereof are different.

The N-gate NMOSFET is an NMOSFET whose on-threshold voltage Vth is changed by changing the polarity of the gate electrode. The typical NMOSFET has an on-threshold voltage Vth of about 0.7 V. On the other hand, in the N-gate NMOSFET, the on-threshold voltage Vth is about −0.15 V.

The N-gate NMOSFET and the typical NMOSFET have exactly the same device structure, except that the polarities of the gate electrodes are different. Therefore, as long as the N-gate NMOSFET and the typical NMOSFET are formed on a common silicon substrate, their element characteristics (on-threshold voltage Vth, on-resistance Ron, etc.) vary in the same way.

Further, as described above, the gates of the transistors MT and M3′ are both connected to the drain of the transistor M3′. The reference current Iref generated by the current source CS2 flows through the drain of the transistor M3′. Therefore, a potential difference corresponding to the on-threshold voltage Vth [M3′] (≈0.7 V) of the transistor M3′ is generated between the gate and source of the transistor M3′.

The on-threshold voltage Vth [M3′] of the transistor M3′ is much higher than the on-threshold voltage Vth [M2′] of the transistor MT (≈0.15V). Therefore, the transistor MT is sufficiently driven in a linear region. In the linear region, the characteristic between the drain and source of the transistor MT is equivalent to that of a resistor. That is, the current detection signal Vs extracted from between the drain and source of the transistor MT is proportional to the sense current Is flowing through the transistor M1.

According to the linear power supply 1 of the third embodiment, there is no need to consider the variations in absolute value of the sense resistor Rs, as in the first embodiment (FIG. 2) and the second embodiment (FIG. 8). Therefore, it is possible to enhance the detection accuracy of the current detection circuit 11, and hence, it is possible to suppress the variation in the overcurrent upper limit value Iocp.

However, in the linear power supply 1 of the third embodiment, the overcurrent protection circuit 10 is connected between the application terminal of the input voltage Vin and the application terminal of the output voltage Vout. Therefore, the input/output voltage difference (Vin−Vout) needs to be higher than the on-threshold voltage Vth [M7] of the transistor M7 in order not to interfere with the overcurrent protection operation.

In the linear power supply 1 of the third embodiment, the transistor MT is formed of an N-gate NMOSFET, and the transistor M3′ is formed of a typical NMOSFET. However, the combination of the second transistor and the third transistor is not limited to the above. For example, the transistor MT may be formed of a depletion-mode NMOSFET, and the transistor M3′ may be formed of an enhancement-mode NMOSFET.

### Linear Power Supply (Fourth Embodiment)

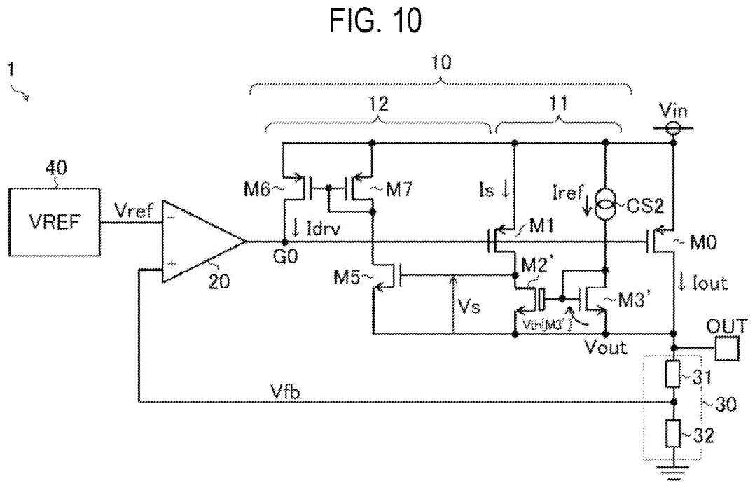

FIG. 10 is a diagram showing a fourth embodiment of the linear power supply. The linear power supply 1 of the fourth embodiment is based on the above-described third embodiment (FIG. 9), but omits the amplifier A2 and the voltage source E2 among the constituent elements of the protection signal generation circuit 12.

Referring to FIG. 10, the gate of the transistor M5 is connected to the drain of the transistor MT. The transistor M5 operates to generate a drive current Idry (overcurrent protection signal OCP) depending on whether the current detection signal Vs applied between the gate and source thereof is higher than the on-threshold voltage Vth [M5].

According to the linear power supply 1 of the fourth embodiment, the circuit size can be reduced as compared with the third embodiment (FIG. 9).

However, in the linear power supply 1 of the fourth embodiment, the overcurrent protection circuit 10 is connected between the application terminal of the input voltage Vin and the application terminal of the output voltage Vout, as in the third embodiment (FIG. 9) described above. Therefore, the input/output voltage difference (Vin−Vout) needs to be higher than the combined on-threshold voltage (Vth [M5]+Vth [M7]) of the transistors M5 and M7 in order not to interfere with the overcurrent protection operation.

In addition, the linear power supply 1 of the fourth embodiment is susceptible to the variation in on-threshold voltage and the temperature characteristics of the transistor M5. Therefore, it should be noted that the effect of suppressing the variation in the overcurrent upper limit value Iocp may be smaller than in the third embodiment (FIG. 9).

### Linear Power Supply (Fifth Embodiment)

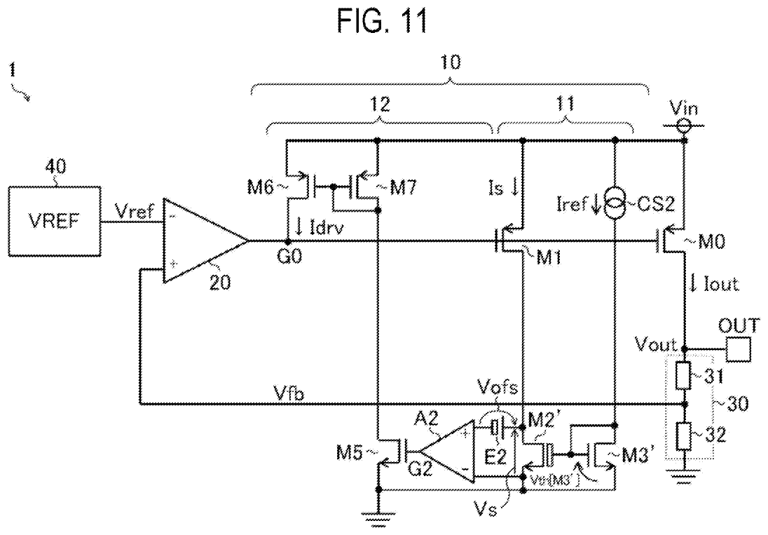

FIG. 11 is a diagram showing a fifth embodiment of the linear power supply. The linear power supply 1 of the fifth embodiment is based on the third embodiment (FIG. 9) described above, and the sources of the transistors M2′, M3′ and M5 are all connected to the ground terminal instead of the application terminal of the output voltage Vout.

That is, in the linear power supply 1 of the fifth embodiment, the overcurrent protection circuit 10 is connected between the application terminal of the input voltage Vin and the ground terminal. Therefore, unlike the third embodiment (FIG. 9) described above, there is no need to worry about the input-output voltage difference (Vin−Vout).

### Linear Power Supply (Sixth Embodiment)

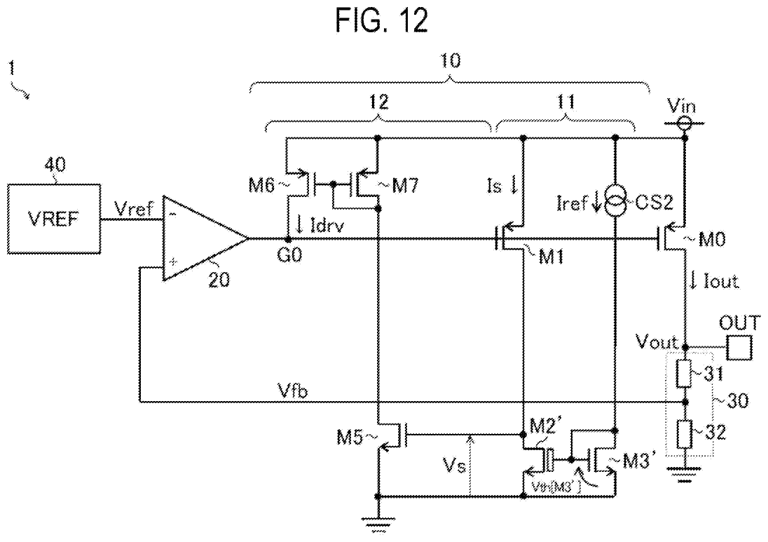

FIG. 12 is a diagram showing a sixth embodiment of the linear power supply. The linear power supply 1 of the sixth embodiment is based on the fourth embodiment (FIG. 10) described above, and the sources of the transistors M2′, M3′ and M5 are all connected to the ground terminal instead of the application terminal of the output voltage Vout. Alternatively, the linear power supply 1 of the sixth embodiment is based on the fifth embodiment (FIG. 11) described above, and omits the amplifier A2 and the voltage source E2 described above among the constituent elements of the protection signal generation circuit 12.

According to the linear power supply 1 of the sixth embodiment, unlike the fourth embodiment (FIG. 10) described above, there is no need to worry about the input-output voltage difference (Vin−Vout). Further, the circuit size can be reduced as compared with the fifth embodiment (FIG. 11) described above. However, it should be noted that the effect of suppressing the variation in the overcurrent upper limit value Iocp may be reduced.

### Linear Power Supply (Seventh Embodiment)

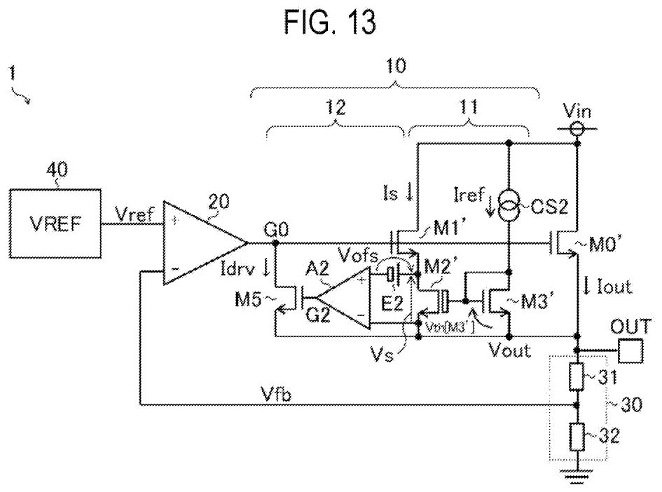

FIG. 13 is a diagram showing a seventh embodiment of the linear power supply. The linear power supply 1 of the seventh embodiment is based on the third embodiment (FIG. 9) described above, and the P-channel type output transistor M0 and the transistor M1 are replaced with an N-channel type output transistor M0′ and a transistor M1′ (e.g., NMOSFETs), respectively.

Referring to FIG. 13, drains of the output transistor M0′ and the transistor M1′ are connected to the application terminal of the input voltage Vin. A source of the output transistor M0′ is connected to the application terminal of the output voltage Vout. A source of the transistor M1′ is connected to the drain of the transistor M2′. Gates of the output transistor M0′ and the transistor M1′ are both connected to the output terminal of the driver 20.

The transistor M1′ corresponds to a first transistor configured to pass a sense current Is corresponding to the output current Iout.

The transistor M2′ corresponds to a second transistor provided on a path through which the sense current Is flows, and is configured such that the voltage across the transistor (the drain-source voltage Vds) is extracted as a current detection signal Vs.

The transistor M3′ has a higher on-threshold voltage Vth [M3′] than the transistor M2′, and corresponds to a third transistor configured to drive the transistor M2′ in a linear region.

As described above, the second transistor and the third transistor constituting the current detection circuit 11 may be provided on the source side of the first transistor. For example, when the second transistor and the third transistor are provided on the source side of the N-channel transistor M1′, the N-channel transistors M2′ and M3′ may be used as the second transistor and the third transistor, respectively.

Further, in the linear power supply 1 of the seventh embodiment, the input polarity of the driver 20 is reversed due to the above change. Referring to FIG. 13, the driver 20 is an operational amplifier that generates a gate signal G0 of the output transistor M0′ so that the feedback voltage Vfb inputted to the inverting input terminal (−) matches the reference voltage Vref inputted to the non-inverting input terminal (+). The gate signal G0 rises when the feedback voltage Vfb is lower than the reference voltage Vref, and falls when the feedback voltage Vfb is higher than the reference voltage Vref.

Furthermore, in the linear power supply 1 of the seventh embodiment, the transistors M6 and M7 are omitted from the constituent elements of the protection signal generation circuit 12. Referring to FIG. 13, the drain of the transistor M5 is connected to the output terminal of the driver 20.

When the current detection signal Vs (=Is×Rs) is lower than the offset voltage Vofs, the gate signal G2 outputted from the amplifier A2 stays at a low level. Therefore, the transistor M5 is fully turned off, so that the gate and source of the output transistor M0′ are open. As a result, an on-resistance of the output transistor M0′ is not increased, and the output current Iout flowing through the output transistor M0′ is not limited (that is, the overcurrent protection operation is released).

On the other hand, when the output current Iout increases due to an output abnormality or the like and the current detection signal Vs becomes higher than the offset voltage Vofs, the gate signal G2 outputted from the amplifier A2 rises from the low level according to a difference value between the two voltages. Therefore, the transistor M5 is turned on and the drive current Idrv (corresponding to the overcurrent protection signal OCP) flows between the gate and source of the output transistor M0′, so that the gate signal G0 decreases and the gate-source voltage of the output transistor M0′ is pulled down. As a result, the on-resistance of the output transistor M0′ increases, and the output current Iout is limited (that is, the overcurrent protection operation is activated). Consequently, the gate control of the transistor M5 is balanced in a state in which the current detection signal Vs and the offset voltage Vofs are imaginary-shorted.

Thus, even when the output transistor M0′ and the transistor M1′ are NMOSFETs, it is possible to apply the current detection circuit 11 that does not use the sense resistor Rs. Therefore, it is possible to enhance the detection accuracy of the current detection circuit 11, and hence, it is possible to suppress the variation in the overcurrent upper limit value Iocp.

### Linear Power Supply (Eighth Embodiment)

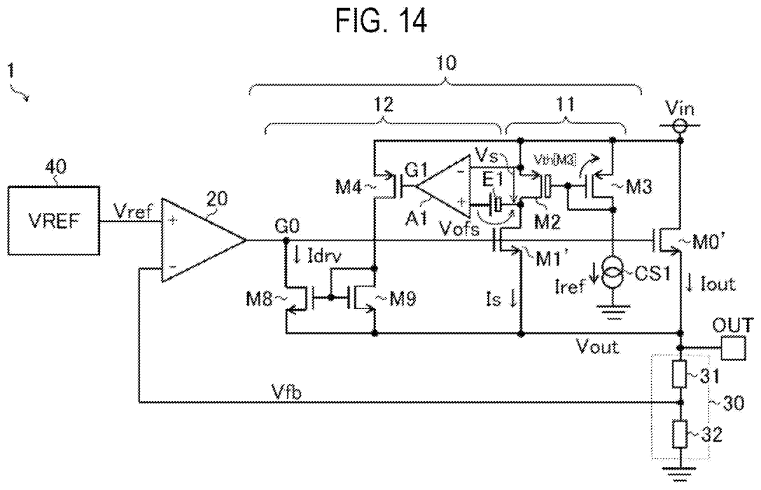

FIG. 14 is a diagram showing an eighth embodiment of the linear power supply. The linear power supply 1 of the eighth embodiment is based on the seventh embodiment (FIG. 13) described above, and the circuit configuration of the overcurrent protection circuit 10 is modified.

Specifically, referring to FIG. 14, the current detection circuit 11 includes transistors M2 and M3 and a current source CS1 (e.g., see FIG. 8) instead of the transistors MT and M3′ and the current source CS2 described above.

Further, the protection signal generation circuit 12 includes an amplifier A1, a voltage source E1 and a transistor M4 (e.g., see FIG. 8), and transistors M8 and M9 (e.g., NMOSFETs) instead of the amplifier A2, the voltage source E2 and the transistor M5 described above.

The source of the transistor M1′ is connected to the source of the output transistor M0′ (i.e., the application terminal of the output voltage Vout). The drain of the transistor M1′ is connected to the drain of the transistor M2. The source of the transistor M2 is connected to the drain of the output transistor M0′ (i.e., the application terminal of the input voltage Vin). Since the connection relationship between the transistors M2 and M3 and the current source CS1 is the same as that of the second embodiment (FIG. 8) described above, redundant description will be omitted.

The transistor M1′ corresponds to a first transistor configured to pass a sense current Is corresponding to the output current Iout.

The transistor M2 corresponds to a second transistor provided on a path through which the sense current Is flows, and is configured such that the voltage across the transistor (i.e., the drain-source voltage Vds) is extracted as a current detection signal Vs.

The transistor M3 corresponds to a third transistor having a higher on-threshold voltage Vth [M3] than the transistor M2 and is configured to drive the transistor M2 in a linear region.

As described above, the second transistor and the third transistor constituting the current detection circuit 11 may be provided on the drain side of the first transistor. For example, when the second and third transistors are provided on the drain side of the N-channel transistor Mr, P-channel transistors M2 and M3 may be used as the second and third transistors, respectively.

Since the connection relationship between the amplifier A1, the voltage source E1, and the transistor M4 is the same as that of the second embodiment (FIG. 8), a redundant description will be omitted. The drain of the transistor M4 is connected to a drain of the transistor M9.

Sources of the transistors M8 and M9 are both connected to the application terminal of the output voltage Vout. Gates of the transistors M8 and M9 are both connected to the drain of the transistor M9. A drain of the transistor M8 is connected to the output terminal of the driver 20. The transistors M8 and M9 connected in this manner function as a current mirror that mirrors the drain current of the transistor M4 to generate a drive current Idry flowing between the gate and source of the output transistor M0′.

When the current detection signal Vs (=Is×Rs) is lower than the offset voltage Vofs, the gate signal G1 outputted from the amplifier A1 stays at a high level. Therefore, the transistor M4 is fully turned off, so that the current mirror consisting of the transistors M8 and M9 does not operate and the gate and source of the output transistor M0′ are open. As a result, the on-resistance of the output transistor M0′ is not increased, and the output current Tout flowing through the output transistor M0′ is not limited (that is, the overcurrent protection operation is released).

On the other hand, when the output current Tout increases due to an output abnormality or the like and the current detection signal Vs becomes higher than the offset voltage Vofs, the gate signal G1 outputted from the amplifier A1 decreases from the high level according to a difference value between the two voltages. Therefore, the transistor M4 is turned on and the drive current Idry (corresponding to the overcurrent protection signal OCP) flows between the gate and source of the output transistor M0′, so that the gate signal G0 is lowered and the gate-source voltage of the output transistor M0′ is pulled down. As a result, the on-resistance of the output transistor M0′ increases, and the output current Tout is limited (that is, the overcurrent protection operation is activated). Consequently, the gate control of the transistor M4 is balanced in a state in which the current detection signal Vs and the offset voltage Vofs are imaginary-shorted.

According to the linear power supply 1 of the eighth embodiment, as in the seventh embodiment (FIG. 13), it is possible to enhance the detection accuracy of the current detection circuit 11, and hence, it is possible to suppress the variation in the overcurrent upper limit value Iocp.

However, in the linear power supply 1 of the eighth embodiment, the overcurrent protection circuit 10 is connected between the application terminal of the input voltage Vin and the application terminal of the output voltage Vout. Therefore, it should be noted that the input/output voltage difference (Vin−Vout) needs to be higher than the on-threshold voltage Vth [M9] of the transistor M9 in order not to interfere with the overcurrent protection operation.

### Linear Power Supply (Ninth Embodiment)

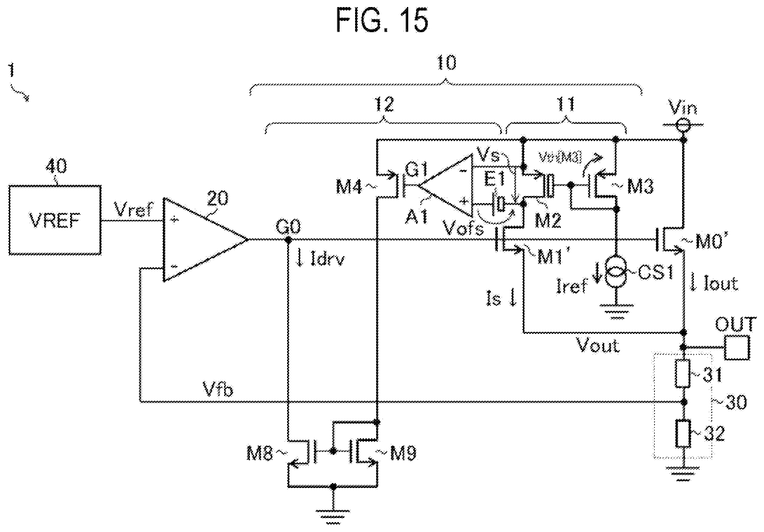

FIG. 15 is a diagram showing a ninth embodiment of the linear power supply. The linear power supply 1 of the ninth embodiment is based on the eighth embodiment (FIG. 14) described above, and the sources of the transistors M8 and M9 are both connected to the ground terminal instead of the application terminal of the output voltage Vout.

That is, in the linear power supply 1 of the ninth embodiment, the overcurrent protection circuit 10 is connected between the application terminal of the input voltage Vin and the ground terminal. Therefore, unlike the eighth embodiment (FIG. 14) described above, there is no need to worry about the input-output voltage difference (Vin−Vout).

### Linear Power Supply (Tenth Embodiment)

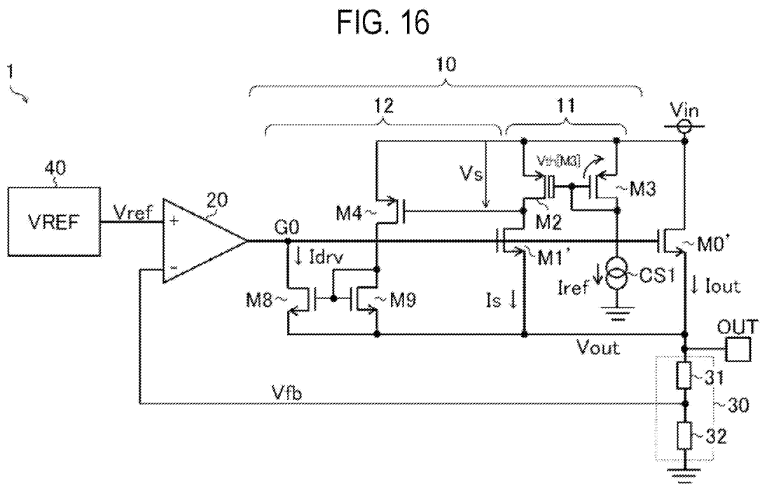

FIG. 16 is a diagram showing a tenth embodiment of the linear power supply. The linear power supply 1 of the tenth embodiment is based on the eighth embodiment (FIG. 14) described above, but omits the amplifier A1 and the voltage source E1 described above among the constituent elements of the protection signal generation circuit 12.

Referring to FIG. 16, the gate of the transistor M4 is connected to the drain of the transistor M2. The transistor M4 connected in this manner operates so as to generate a drive current Idry (i.e., overcurrent protection signal OCP) depending on whether the current detection signal Vs applied between the gate and source of the transistor M4 is higher than the on-threshold voltage Vth [M4].

According to the linear power supply 1 of the tenth embodiment, the circuit size can be reduced as compared with the eighth embodiment (FIG. 14) described above.

### Combination of Embodiments

It should be noted that the first to tenth embodiments described so far may be combined as appropriate as long as there is no contradiction. For example, although not described again, by combining the ninth embodiment (FIG. 15) and the tenth embodiment (FIG. 16), the sources of the transistors M8 and M9 may be connected to the ground terminal while omitting the amplifier A1 and the voltage source E1.

### SUMMARY

In the following, the various embodiments described above will be comprehensively described.

For example, the current detection circuit disclosed herein includes: a first transistor configured to pass a sense current corresponding to a monitoring target current; a second transistor provided on a path through which the sense current flows, and configured such that a voltage across the second transistor is extracted as a current detection signal; and a third transistor having a control terminal connected to a control terminal of the second transistor, having a higher on-threshold voltage than the second transistor, and configured to drive the second transistor in a linear region (first configuration).

In the current detection circuit of the first configuration, the second transistor and the third transistor may be MOSFETs of the same structure, and may have gate electrodes with different polarities (second configuration).

In the current detection circuit of the second configuration, the second transistor may be a PMOSFET having a gate electrode made of P-type polysilicon, and the third transistor may be a PMOSFET having a gate electrode made of N-type polysilicon (third configuration).

In the current detection circuit of the second configuration, the second transistor may be an NMOSFET having a gate electrode made of N-type polysilicon, and the third transistor may be an NMOSFET having a gate electrode made of P-type polysilicon (fourth configuration).

In the current detection circuit of the first configuration, the second transistor may be a depletion type NMOSFET, and the third transistor may be an enhancement type NMOSFET (fifth configuration).

Further, for example, the overcurrent protection circuit disclosed herein includes: the current detection circuit of any one of the first to fifth configurations; and a protection signal generation circuit configured to generate an overcurrent protection signal for limiting the monitoring target current to an upper limit value or less based on the current detection signal (sixth configuration).

In the overcurrent protection circuit of the sixth configuration, the protection signal generation circuit may include an amplifier configured to generate the overcurrent protection signal according to a difference between the current detection signal and a detection threshold value (seventh configuration).

In the overcurrent protection circuit of the sixth configuration, the protection signal generation circuit may include a transistor configured to generate the overcurrent protection signal in response to the current detection signal applied between a gate and a source (eighth configuration).

Further, for example, the linear power supply disclosed herein includes: an output transistor configured to be connected between an application terminal of an input voltage and an application terminal of an output voltage; a driver configured to drive the output transistor such that the output voltage or a feedback voltage corresponding to the output voltage matches a reference voltage; and the overcurrent protection circuit of any one of the sixth to eighth configurations configured to use an output current flowing through the output transistor as the monitoring target current (ninth configuration).

In the linear power supply of the ninth configuration, the overcurrent protection circuit may be connected between the application terminal of the input voltage and the application terminal of the output voltage (tenth configuration).

In the linear power supply of the ninth configuration, the overcurrent protection circuit may be connected between the application terminal of the input voltage and a ground terminal (eleventh configuration).

### Other Modifications

It should be noted that the various technical features disclosed herein may be modified in various ways in addition to the above-described embodiments without departing from the gist of the technical concept. That is, the above-described embodiments should be considered as examples and not limitative in all respects. It should be understood that the technical scope of the present disclosure is defined by the claims and all changes falling within the meaning and range of equivalents of the claims are included in the technical scope of the present disclosure.

According to the present disclosure in some embodiments, it is possible to provide a current detection circuit with high detection accuracy, an overcurrent protection circuit using the current detection circuit, and a linear power supply.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A current detection circuit, comprising:
a first transistor configured to pass a sense current corresponding to a monitoring target current;
a second transistor provided on a path through which the sense current flows, and configured such that a voltage across the second transistor is extracted as a current detection signal; and
a third transistor having a control terminal connected to a control terminal of the second transistor, having a higher on-threshold voltage than the second transistor, and configured to drive the second transistor in a linear region.

2. The current detection circuit of claim 1, wherein the second transistor and the third transistor are MOSFETs of the same structure, and have gate electrodes with different polarities.

3. The current detection circuit of claim 2, wherein the second transistor is a PMOSFET having a gate electrode made of P-type polysilicon, and the third transistor is a PMOSFET having a gate electrode made of N-type polysilicon.

4. The current detection circuit of claim 2, wherein the second transistor is an NMOSFET having a gate electrode made of N-type polysilicon, and the third transistor is an NMOSFET having a gate electrode made of P-type polysilicon.

5. The current detection circuit of claim 1, wherein the second transistor is a depletion type NMOSFET, and the third transistor is an enhancement type NMOSFET.

6. An overcurrent protection circuit, comprising:
the current detection circuit of claim 1; and
a protection signal generation circuit configured to generate an overcurrent protection signal for limiting the monitoring target current to an upper limit value or less based on the current detection signal.

7. The overcurrent protection circuit of claim 6, wherein the protection signal generation circuit includes an amplifier configured to generate the overcurrent protection signal according to a difference between the current detection signal and a detection threshold value.

8. The overcurrent protection circuit of claim 6, wherein the protection signal generation circuit includes a transistor configured to generate the overcurrent protection signal in response to the current detection signal applied between a gate and a source.

9. A linear power supply, comprising:
an output transistor configured to be connected between an application terminal of an input voltage and an application terminal of an output voltage;
a driver configured to drive the output transistor such that the output voltage or a feedback voltage corresponding to the output voltage matches a reference voltage; and
the overcurrent protection circuit of claim 6 configured to use an output current flowing through the output transistor as the monitoring target current.

10. The linear power supply of claim 9, wherein the overcurrent protection circuit is connected between the application terminal of the input voltage and the application terminal of the output voltage.

11. The linear power supply of claim 9, wherein the overcurrent protection circuit is connected between the application terminal of the input voltage and a ground terminal.
